(19) United States
(12) Patent Application Publication
(10) Pub. No.: US 2015/0323472 A1
(43) Pub. Date: Nov. 12, 2015

(54) METHOD OF PROVIDING SPECIFIC ABSORPTION RATE (SAR), AND USER TERMINAL

(71) Applicant: Electronics and Telecommunications Research Institute, Daejeon (KR)

(72) Inventors: Ae Kyoung LEE, Daejeon (KR); Hyung Do CHOI, Daejeon (KR)

(21) Appl. No.: 14/707,690

(22) Filed: May 8, 2015

(30) Foreign Application Priority Data
May 9, 2014 (KR) 10-2014-0055775

(51) Int. Cl. G01N 22/00

(52) U.S. Cl. CPC G01N 22/00

(57) ABSTRACT

Provided is a specific absorption rate (SAR) provision method and a user terminal, the method including receiving a radio signal related to a radio service, determining a use pattern of a user sensed by a user terminal in response to the receiving, extracting a standard SAR for a body part of the user based on the determined use pattern, and determining a measured SAR for the body part of the user based on the extracted standard SAR and a transmission power of the user terminal.

### CROSS-REFERENCE TO RELATED APPLICATION

This application claims the priority benefit of Korean Patent Application No. 10-2014-0055775, filed on May 9, 2014, in the Korean Intellectual Property Office, the disclosure of which is incorporated herein by reference.

### BACKGROUND

1. Field of the Invention

Embodiments of the present invention relate to a method of providing a specific absorption rate (SAR) of a body part of a user, and a user terminal.

2. Description of the Related Art

Recently, devices based on electromagnetic fields are increasing, and frequencies of using the devices are correspondingly increasing. Accordingly, users may acquire a convenience while experiencing an inconvenience due to an exposure to electromagnetic fields that may cause deterioration in health.

The users may acquire information on a biological effect of the electromagnetic fields through a medium such as a television, the Internet, and the like. However, such information may differ from an electromagnetic fields exposure level in an actual environment and thus, the users may feel doubt and uncomfortable.

In general, most countries may regulate the specific absorption rate (SAR) absorbed in the human head exposed to electromagnetic fields radiated from a cellular phone. Here, the SAR may indicate an electromagnetic fields absorption power per unit mass, which is absorbed into a body in a radio frequency band.

An interrelationship between the body and the electromagnetic fields emitted from the cellular phone has not been obviously proved so far. In 2011, the International Agency for Research on Cancer (IARC), one of affiliate research institutes of World Health Organization (WHO), classified the electromagnetic fields generated from the cellular phone as a cancer-causing substance level 2B, based on a result of research on a relationship between a use of the cellular phone and an occurrence of a brain tumor. From this, concerns about deterioration in health have been growing among the users.

### SUMMARY

An aspect of the present invention provides a specific absorption rate (SAR) provision method enabling a user to individually recognize a state for each body part of the user by providing the SAR for each body part to the user, and a user terminal for providing the SAR.

According to an aspect of the present invention, there is provided an SAR provision method including receiving a radio signal related to a radio service, determining a use pattern of a user sensed by a user terminal in response to the receiving, extracting a standard SAR which is an SAR in a standard phantom such as the SAM or flat phantom for a body part of the user based on the determined use pattern, and determining a measured SAR for the body part of the user based on the extracted standard SAR and a transmission power of the user terminal.

The extracting may include extracting the standard SAR for the body part of the user based on at least one of an age of the user, a type of the user terminal, and a position of an antenna of the user terminal.

The extracting may include extracting the standard SAR for the body part of the user based on a standard distance between the user and the user terminal.

The determining of the measured SAR may include determining the measured SAR for the body part of the user based on an actual distance between the user and the user terminal.

The determining of the measured SAR may include determining a measured SAR for at least one of a left portion and a right portion of a head of the user based on a movement of the user sensed by the user terminal.

The SAR provision method may further include displaying at least one of the standard SAR, the measured SAR, a standard SAR accumulated during a predetermined time, and a measured SAR accumulated during the predetermined time for the body part of the user.

According to another aspect of the present invention, there is also provided an SAR provision method including receiving a radio signal related to a radio service, extracting a standard SAR for a body part of a user related to the radio service, and determining a measured SAR for the body part of the user based on the extracted standard SAR and a power of the radio signal.

The extracting may include extracting the standard SAR for the body part of the user based on a standard distance between the user and a user terminal.

The determining may include determining the measured SAR for the body part of the user based on an actual distance between the user and a user terminal.

The SAR provision method may further include displaying at least one of the standard SAR, the measured SAR, a standard SAR accumulated during a predetermined time, and a measured SAR accumulated during the predetermined time for the body part of the user.

According to still another aspect of the present invention, there is also provided a user terminal including a receiver to receive a radio signal related to a radio service, a use pattern determiner to determine a use pattern of a user sensed by the user terminal in response to receiving of the radio signal, an extractor to extract a standard SAR for a body part of the user based on the determined use pattern, and a measured SAR determiner to determine a measured SAP for the body part of the user based on the extracted standard SAR and a transmission power of the user terminal.

The extractor may extract the standard SAR for the body part of the user based on at least one of an age of the user, a type of the user terminal, and a position of an antenna of the user terminal.

The extractor may extract the standard SAR for the body part of the user based on a standard distance between the user and the user terminal.

The measured SAR determiner may determine the measured SAR for the body part of the user based on an actual distance between the user and the user terminal.

The measured SAR determiner may determine a measured SAR for at least one of a left portion and a right portion of a head of the user based on a movement of the user sensed by the user terminal.

The user terminal may display at least one of the standard SAR, the measured SAR, a standard SAR accumulated during a predetermined time, and a measured SAR accumulated during the predetermined time.

According to yet another aspect of the present invention, there is also provided a user terminal including a receiver to receive a radio signal related to a radio service, an extractor to extract a standard SAR for a body part of a user related to the radio service, and a determiner to determine a measured SAR for the body part of the user based on the extracted standard SAR and a power of the radio signal.

The extractor may extract the standard SAR for the body part of the user based on a standard distance between the user and the user terminal.

The determiner may determine the measured SAR for the body part of the user based on an actual distance between the user and the user terminal.

The user terminal may display at least one of the standard SAR, the measured SAR, a standard SAR accumulated during a predetermined time, and a measured SAR accumulated during the predetermined time.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIGS. 1A through 1C illustrate examples of a use pattern for a user terminal according to an example embodiment;

FIG. 2 illustrates a method of providing a measured SAR corresponding to a body part of a user based on a use pattern of a user terminal according to an example embodiment;

FIG. 3 illustrates a method of providing a measured SAR for a body part of a user based on a radio service related to a radio signal according to an example embodiment;

FIGS. 4A through 4C illustrate examples of a three-dimensional (3D) distribution and a cross-section distribution of a standard SAR for a head of a user based on a change in an age of the user according to an example embodiment;

FIGS. 5A and 5B illustrate examples of a SAR distribution changed based on a contact position of a user terminal and an inclination of the user terminal according to an example embodiment;

FIG. 6 illustrates a method of measuring a standard SAR for a trunk based on a distance between a user and a user terminal according to an example embodiment;

FIG. 7 illustrates a standard SAR for a trunk varying based on a distance between a user and a user terminal according to an example embodiment;

FIG. 8 illustrates data collected and retained in a user terminal according to an example embodiment;

FIG. 9 illustrates an example of providing real time electromagnetic fields absorption information according to an example embodiment;

FIG. 10 illustrates an example of providing electromagnetic fields absorption history information according to an example embodiment;

FIG. 11 illustrates electromagnetic fields absorption history information associated with a head of a user according to an example embodiment;

FIG. 12 illustrates a user terminal to provide a measured SAR corresponding to a body part of a user based on a use pattern of a user terminal according to an example embodiment; and

FIG. 13 illustrates a user terminal to provide a measured SAR for a body part of a user based on a radio service related to a radio signal according to an example embodiment.

### DETAILED DESCRIPTION

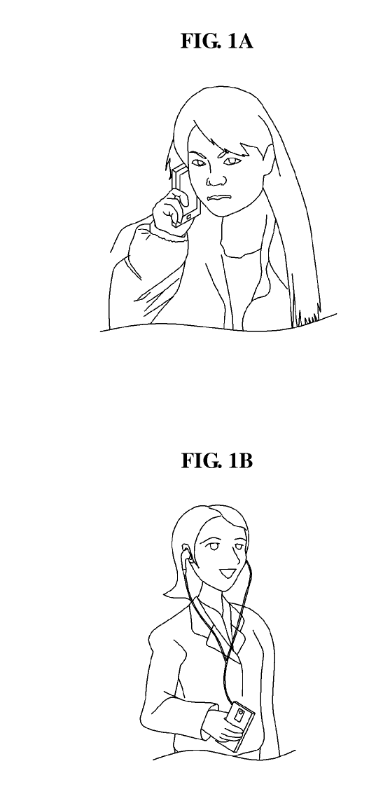

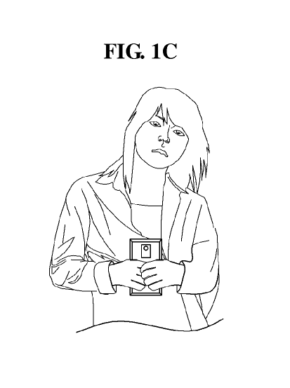

FIGS. 1A through 1C illustrate examples of a use pattern of a user terminal according to an example embodiment.

Referring to FIGS. 1A through 1C, the user terminal may provide various services to a user. Here, the services may refer to all services provided through a radio signal.

The user terminal may receive a radio signal related to a radio service to provide the radio service to the user. The user terminal may determine the use pattern of the user sensed by the user terminal using an interface and a sensor of the user terminal.

The user terminal may provide at least one of a standard specific absorption rate (SAR) and a measured SAR for a body part of the user based on the use pattern. The standard SAR may refer to data extracted by testing an SAR for a body part based on a standard model.

The standard model may be used to extract the standard SAR by disposing a specific anthropomorphic mannequin (SAM) phantom corresponding to a head among body parts of the user and a flat phantom corresponding to a trunk, an arm, and a leg among the body parts of the user, and measuring electromagnetic fields absorbed into a phantom based on a change in an age of the user and a change in a type of the user terminal.

The standard SAR may include a standard SAR for the head among the body parts of the user. In this example, the standard SAR for the head may include an SAR distribution measured using the SAM phantom. Also, the standard SAR for the head may include an SAR distribution measured for each age of the user based on an anatomical model of the head. Here, the SAM phantom may be a standard phantom corresponding to a single form unrelated to an age.

The standard SAR may include a standard SAP of the trunk among the body parts of the user. In this example, the standard SAR for the trunk may include an SAR distribution measured based on an average distance between the flat phantom and the user terminal.

The measured SAR may be obtained through conversion of the standard SAR by reflecting user information and user terminal information.

The user terminal may store the standard SAR extracted based on the standard model in a database, and extract a standard corresponding to the user information from the database.

The user terminal may sense a change in a movement of the user using a sensor and an application programming interface (API) of an operating system (OS) included in the user terminal. The user terminal may determine the use pattern based on the sensed change in the movement of the user.

The sensor of the user terminal may include, for example, an accelerometer, an orientation meter, a proximity sensor, a gyroscope sensor, and the like. However, the sensor of the user terminal in the present disclosure is not limited thereto. Instead, the sensor may include various types of sensors included in a radio terminal.

Referring to FIG. 1A, to use a voice call service, the user may dispose the user terminal to be adjacent to a face. The user terminal may recognize the face disposed on a screen of the user terminal using the sensor and the interface. Through this, the user terminal may provide the standard SAR and the measured SAR for the body part of the user. For example, the user terminal may provide a standard SAR and a measured SAR extracted based on a distance between the head of the user and the user terminal.

Referring to FIG. 1B, the user may make a voice call using a hands free kit (HFK). In this example, the user terminal may sense the HFK being used by the user. Through this, the user terminal may provide the standard SAR and the measured SAR for the body part of the user. For example, the user terminal may provide a standard SAR and a measured SAR for the trunk of the user based on an HFK use pattern.

Referring to FIG. 1C, the user terminal may provide a text message service. In this example, the user terminal may sense a use pattern by sensing a hand of the user using the sensor. In addition, the user terminal may sense a service being used by the user using the interface.

Accordingly, the user terminal may determine the use pattern of the user, and provide the standard SAR and the measured SAR for the body part of the user based on the determined use pattern.

Also, the user terminal may provide the standard SAR and the measured SAR for the body part based on a preset radio service. In an example, the user terminal may set a body part of the user for the standard SAR and the measured SAR based on the radio service.

For example, the user terminal may determine a body part for each radio service to provide the standard SAR and the measured SAR. Also, the user terminal may determine the body part for each radio service based on a setting of the user, and provide the standard SAR and the measured SAR.

In addition, the user terminal may provide the standard SAR and the measured SAR for the body part of the user and provide a standard SAR, a measured SAR, and an amount of specific energy (SE) accumulated during a period of time determined by the user, so as to assist the user to recognize a state of the user.

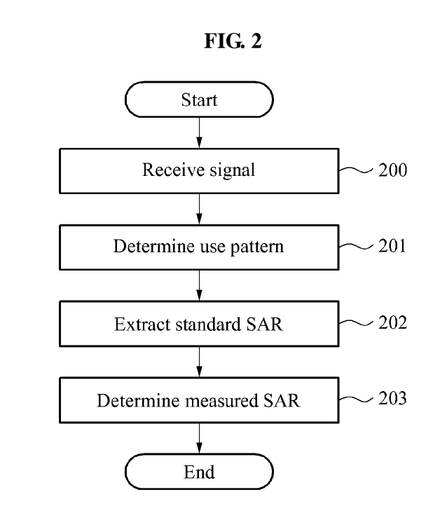

FIG. 2 illustrates a method of providing a measured SAR corresponding to a body part of a user based on a use pattern of a user terminal according to an example embodiment.

In operation 200, the user terminal may receive a radio signal related to a radio service. In operation 201, in response to the receiving, the user terminal may sense a movement of the user sensed by the user terminal Through this, the user terminal may determine the use pattern based on a result of the sensing.

When the user uses a text chat service using the user terminal, the user terminal may recognize the service being used by the user using a sensor and an interface in an operating system (OS), to identify the use pattern.

The user terminal may identify the use pattern by sensing the movement of the user sensed on a screen of the user terminal using the sensor and the interface in the OS.

For example, the user may dispose the user terminal to a predetermined body part of the user to use a service. When the user is to use a voice call service, the user may dispose the user terminal to be adjacent to a head of the user. In this example, the user terminal may sense the movement of the user using the sensor and the interface, and identify the use pattern.

In operation 202, based on the identified use pattern, the user terminal may extract a standard SAR for a body part of the user. The standard SAR may be inversely proportional to a distance between the body part and the user terminal and thus, may vary for each body part. Thus, the user terminal may store a standard model for each body part and provide to the user.

The standard model may be used to extract the standard SAR for the body part of the user based on at least one of an age of the user, a type of the user terminal, and a position of an antenna of the user terminal.

The user terminal may store the standard SAR extracted based on the standard model in a data base. Through this, the user terminal may receive, from the user, at least one of the age of the user, the type of the user terminal, and the position of the antenna of the user terminal, and may extract a standard SAR corresponding to information received by the user from the database.

When the voice call service is provided, the user terminal may extract the standard SAR for at least one of the head and a trunk based on the movement of the user. For example, when the user holds the user terminal to be close to a face in order to make a call, the user terminal may sense the face being in contact with the user terminal using the sensor included in the user terminal. Through this, the user terminal may extract the standard SAR of the head.

When the user makes a call using an HFK, the user terminal may receive an input through an audio output port and extract a standard SAR of the trunk among body parts of the user.

When the user uses a phone call service through a loud speaker (LS), the user terminal may recognize a movement of the user using the sensor and the interface, and sense the phone call service being used by the user using the LS. Through this, the user terminal may extract the standard SAR of the trunk among the body parts of the user.

When the user is to use a text message service, the user terminal may recognize a movement of the user using the sensor and the interface, and sense the text message service being used by the user. Through this, the user terminal may extract the standard SAR of the trunk among the body parts of the user.

Accordingly, the user terminal may determine the use pattern based on the movement of the user sensed for each radio service being used, and extract the standard SAR for the body part of the user based on the determined use pattern.

In operation 203, the user terminal may determine the measured SAR for the body part of the user based on the extracted standard SAR and a transmission power of the user terminal.

For example, the user terminal may determine a measured SAR for the trunk of the user and provide to the user. In this example, the user terminal may determine the measured SAR of the trunk based on an actual distance between the user and the user terminal, and provide to the user.

The user terminal may determine the measured SAR of the trunk using Equation 1 below.

$${SAR}_{real time} = \frac{\begin{matrix}{SAR}_{compliance test} ( s 1 , real phone , flat ) \times \\ {SAR}_{numerical analysis} ( s 2 , reference , flat )\end{matrix}}{{SAR}_{numerical analysis} ( s 1 , reference , flat )} \times \frac{{P}_{real time}}{{P}_{compliance test}} \qquad [ Equation 1 ]$$

In Equation 1, SAR_{real time} denotes the measured SAR. P_{real time} denotes an actual transmission power of the user terminal, and P_{compliance test} denotes a transmission power measured in the user terminal when the standard SAR is extracted based on the standard model.

SAR_{compliance test} (s1, real phone, flat) denotes a maximum value of a standard SAR distribution based on a standard distance s1 between the user and the user terminal. Here, the standard distance s1 may be, for example, less than or equal to 2.5 centimeters (cm).

SAR_{numerical analysis} (s2, reference, flat) denotes a standard SAR of a standard source with respect to an actual measurement distance s2 between the user and the user terminal.

SAR_{numerical analysis} (s1, reference, flat) denotes a standard SAR of a standard source with respect to the standard distance s1 between the user and the user terminal.

For example, the user terminal may provide the measurement SAR of the head of the user. The user terminal may determine the measured SAR using Equation 2 below.

$${SAR}_{real time} = {SAR}_{numerical analysis} ( {M}_{i} , {Y}_{n} ) \times C \times \frac{{P}_{real time}}{{P}_{compliance test}} \qquad [ Equation 2 ]$$

In Equation 2, SAR_{numerical analysis} (Mᵢ, Yₙ) denotes a standard SAR distribution based on an age Yₙ of the user in a standard model Mᵢ of a terminal of which a type is the same as the user terminal.

P_{real time} denotes the actual transmission power of the user terminal, and P_{compliance test} denotes the transmission power measured in the user terminal when the standard SAR is extracted based on the standard model.

C may be an SAR modification factor, and expressed as

$$C = \frac{{SAR}_{compliance test} ( real phone , SAM )}{{SAR}_{numerical analysis} ( {M}_{i} , SAM )} .$$

SAR_{compliance test} (real phone, SAM) denotes a maximum value of a standard SAR distribution extracted for the terminal of which the type is the same as the user terminal, and SAR_{numerical analysis} (Mᵢ, SAM) denotes a standard SAR distribution in the terminal of which the type is the same as the user terminal.

Accordingly, the standard model of the head of the user may be normalized by extracting a standard SAR distribution for each of the type of the user terminal, the position of the antenna, and the age of the user. The user terminal may store the normalized standard SAR distribution in a database, and provide a corresponding standard SAR in response to a request from a user.

In addition, the user terminal may determine the measured SAR for at least one of a left portion and a right portion of the head of the user based on the movement of the user sensed by the user terminal, and may provide a result of the determining to the user. Thus, the user terminal may recognize a use pattern related to the left portion and the right portion of the head of the user using, for example, the sensor included in the user terminal. Through this, the user terminal may determine the measured SAR for at least one of the left portion and the right portion of the head of the user, and provide the result of determining to the user.

The user terminal may measure a use frequency for each of the left portion and the right portion of the head using the sensor and the interface, and provide, to the user, at least one of the measured SAR of each of the left portion and the right portion of the head and the use frequency of each of the left portion and the right portion of the head.

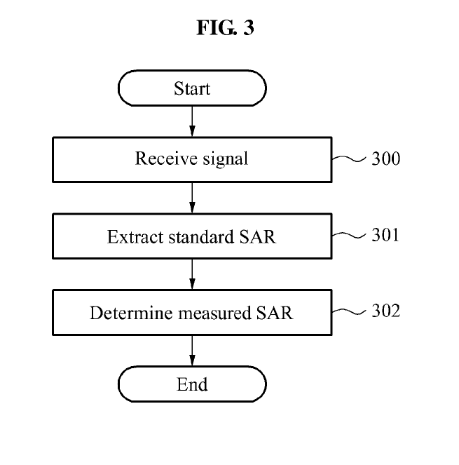

FIG. 3 illustrates a method of providing a measured SAR for a body part of a user based on a radio service related to a radio signal according to an example embodiment.

In operation 300, a user terminal may receive the radio signal related to the radio service.

In operation 301, the user terminal may extract a standard SAR for the body part of the user related to the radio service. A position of the user terminal corresponding to the body part of the user may vary based on the radio service provided to the user. Although the radio service is identically provided to the user, the position of the user position corresponding to the body part of the user may vary based on a usage of the user. For example, when a voice call service is provided to the user, the user terminal may be disposed around a head of the user. Depending on a case, the user terminal may be disposed to a trunk or a waist of the user although an identical radio service is provided. Thus, the user terminal may extract the standard SAR related to the body part of the user corresponding to the position of the user terminal to which the radio service is provided. The position of the user terminal may be measured by the sensor of the user terminal in real time, or arbitrarily set by the user or a manufacturer of the user terminal to correspond to the radio service.

In this instance, the standard SAR may be extracted based on the standard model. For example, the standard SAR of the head may be used to extract a standard SAR distribution by disposing an SAM phantom in lieu of the head of the user and measuring an amount of electromagnetic fields absorbed into the SAM phantom based on an age of the user, a type of the user terminal, and a position of an antenna as variables.

Also, a standard model of the trunk may be used to extract the standard SAR distribution by disposing a phantom in lieu of the trunk of the user and measuring an amount of electromagnetic fields absorbed into the phantom based on a distance between the phantom and the user terminal.

The user terminal may store the standard SAR distribution extracted based on the standard model of the body part of the user in a database, extract and provide a standard SAR in response to a request from the user.

In this example, the user terminal may set the body part matching a type of the radio service to extract the standard SAR. Also, the user may individually set the body part for each radio service to extract the standard SAR.

For example, when the user uses the voice call service, the user terminal may set the standard SAR to be extracted for the head of the user. When the user uses a text message service, the user terminal may set the standard SAR to be extracted for the trunk of the user.

In operation 302, the user terminal may determine the measured SAR for the body part of the user based on the extracted standard SAR and a power of a signal related to the radio service.

The user terminal may determine the measured SAR for the trunk using Equation 3 below.

$${SAR}_{real time} = \frac{\begin{matrix}{SAR}_{compliance test} ( s 1 , real phone , flat ) \times \\ {SAR}_{numerical analysis} ( s 2 , reference , flat )\end{matrix}}{{SAR}_{numerical analysis} ( s 1 , reference , flat )} \times \frac{{P}_{real time}}{{P}_{compliance test}} \qquad [ Equation 3 ]$$

In Equation 3, SAR_{real time} denotes the measured SAR. P_{real time} denotes an actual transmission power of the user terminal, and P_{compliance test} denotes a transmission power measured in the user terminal when the standard SAR is extracted based on the standard model.

SAR_{compliance test} (s1, real phone, flat) denotes a maximum value of a standard SAR distribution based on a standard distance s1 between the user and the user terminal.)

SAR_{numerical analysis} (s2, reference, flat) denotes a standard SAR with respect to an actual measurement distance s2 between the user and the user terminal.

SAR_{numerical analysts} (s1, reference, flat) denotes a standard SAR with respect to the standard distance s1 between the user and the user terminal.

For example, the user terminal may provide the measured SAR for the head of the user. The user terminal may determine the measured SAR for the trunk using Equation 4 below.

$${SAR}_{real time} = {SAR}_{numerical analysis} ( {M}_{i} , {Y}_{n} ) \times C \times \frac{{P}_{real time}}{{P}_{compliance test}} \qquad [ Equation 4 ]$$

In Equation 4, SAR_{numerical analysis} (Mᵢ, Yₙ) denotes a standard SAR distribution based on an age Yₙ of the user in a standard model Mᵢ of a terminal of which a type is the same as the user terminal.

P_{real time} denotes the actual transmission power of the user terminal, and P_{compliance test} denotes the transmission power measure in the user terminal when the standard SAR is extracted based on the standard model.

C may be an SAP modification factor, and expressed as

$$C = \frac{{SAR}_{compliance test} ( real phone , SAM )}{{SAR}_{numerical analysis} ( {M}_{i} , SAM )} .$$

SAR_{compliance test} (real phone, SAM) denotes the maximum value of the standard SAR distribution extracted for the terminal of which the type is the same as the user terminal, and SAR_{numerical analysis} (Mᵢ, SAM) denotes the standard SAR distribution in the terminal of which the type is the same as the user terminal.

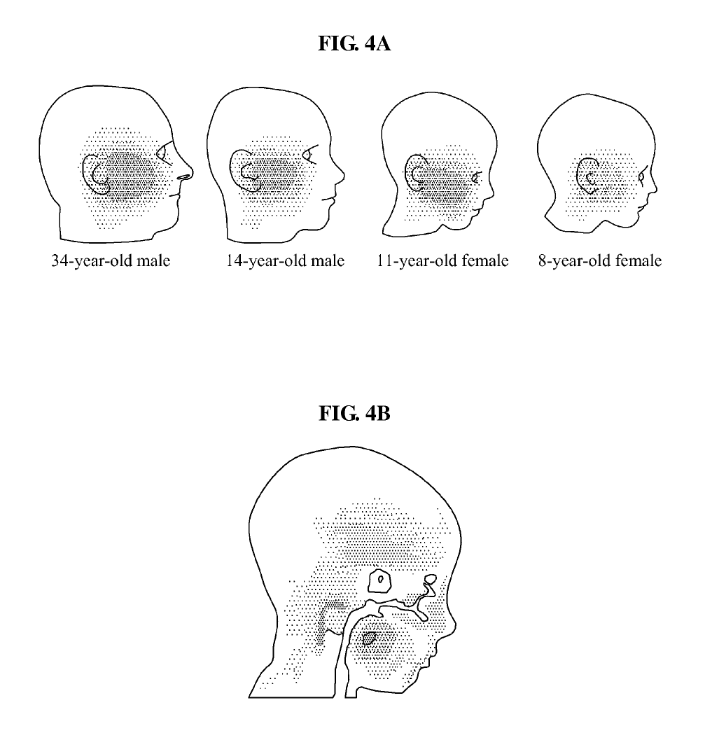

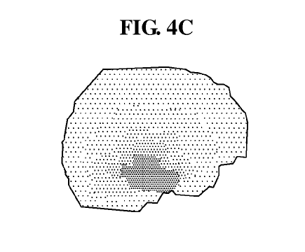

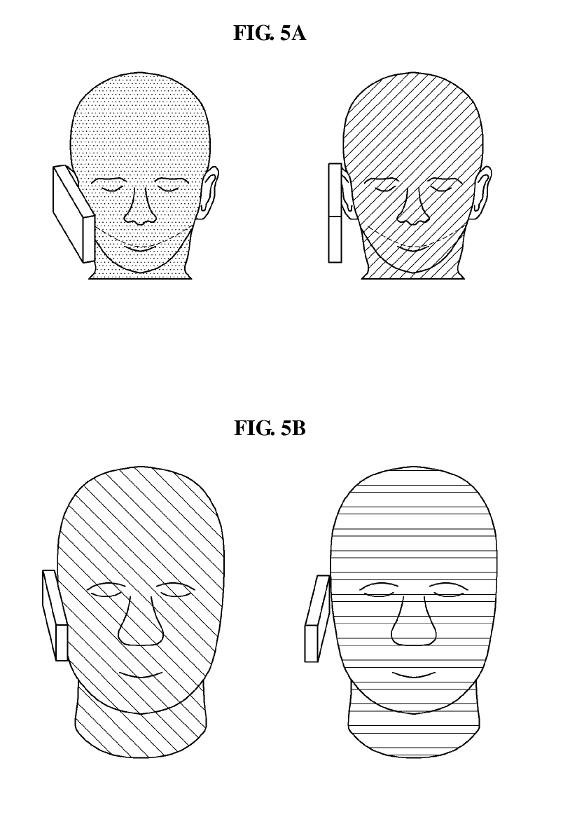

FIGS. 4A through 4C illustrate examples of a 3D distribution and a cross-section distribution of a standard SAR for a head of a user based on a change in an age of the user according to an example embodiment.

Referring to FIGS. 4A through 4C, a user terminal may store a standard SAR distribution in a database.

The standard SAR may vary based on a variable such as the age of the user, a contact position of the user terminal, an inclination of the user terminal, a type of the user terminal, a position of an antenna, and the like.

Referring to FIG. 4A, a standard SAR distribution may be indicated based on the age of the user. As shown in FIG. 4A, the standard SAR distribution may vary based on the age of the user.

The user terminal may extract the standard SAR distribution using a standard model in advance of storing in a database. Through this, the user terminal may quickly provide the standard SAR using the database, and quickly provide a measured SAR determined based on the standard SAR.

In this example, when a quantity of data on the standard model is greater than a storage capacity allowed by the user terminal, the user terminal may store a predetermined cross-section distribution of the standard model in the database. For example, a standard model of a head is to be stored in a database, the user terminal may store a predetermined cross-section distribution of a brain organization.

FIGS. 5A and 5B illustrate examples of a SAR distribution changed based on a contact position of a user terminal and an inclination of the user terminal according to an example embodiment.

A standard SAR may vary based on a variable such as an age of a user, a contact position of the user terminal, an inclination of the user terminal, a type of the user terminal, a position of an antenna, and the like.

For example, the type of the user terminal may be classified into a flip type, a slide type, and a bar type. The position of the antenna of the user may be classified into an upper end and a lower end of the user terminal.

When the user terminal corresponds to the flip type and the antenna of the user terminal is disposed at the lower end, the standard SAR distribution varying based on the inclination of the user terminal and the contact position between the user and the user terminal may be indicated with reference to FIG. 5A.

Thus, the standard SAR distribution may vary when the inclination of the user terminal and the contact position between the user and the user terminal are changed.

Referring to FIG. 5B, the standard SAR distribution may vary based on the age of the user.

Since the standard SAR is changed by numerous variables, a standard model may be used to extract the standard SAR distribution varying in response to a change in each of the variables based on the numerous variables.

By storing the standard model of each body part of the user in a database, the user terminal may extract a standard SAR corresponding to a request from the user and provide a result of the extracting to the user.

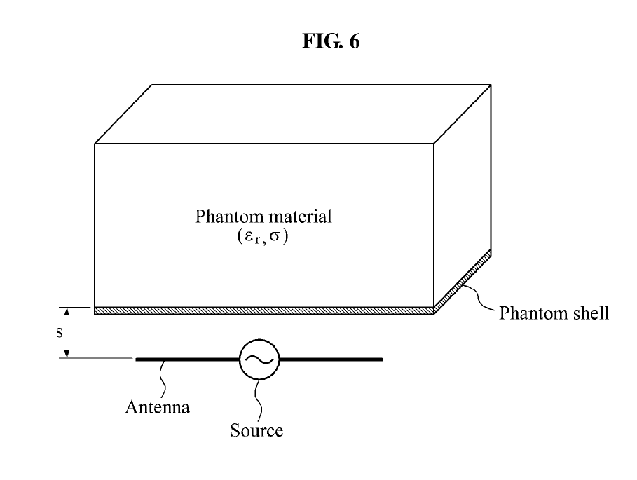

FIG. 6 illustrates a method of measuring a standard SAR for a trunk based on a distance between a user and a user terminal according to an example embodiment.

Referring to FIG. 6, a flat phantom may correspond to each of the trunk, an arm, and a leg of the user. Here, a material of the flat phantom may be set based on a measurement standard or a public announcement made by a government. Also, a source may correspond to the user terminal Thus, a standard model may obtained by disposing a device, for example, a cellular phone, a tablet personal computer (PC), and the like in a position of the source, and normalizing an SAR distribution of the trunk extracted based on the device.

In this example, a distance s may be set based on a distance set by a law or a distance set by a manufacturer as a reference. The distance s may vary based on the device.

Regulations related to a material of a phantom may be based on the measurement standard or, for example, an official announcement made by a government.

The phantom may correspond to the trunk of the user. In this example, the standard model of the trunk may be used to measure an amount of electromagnetic fields absorbed into the phantom and extract the standard SAR.

The user terminal may store, in the database, a standard SAR extracted for each of a distance between the user and the user terminal, a type of the user terminal, and a position of an antenna, and extract a standard SAR corresponding to a request from the user, thereby providing a result of the extracting.

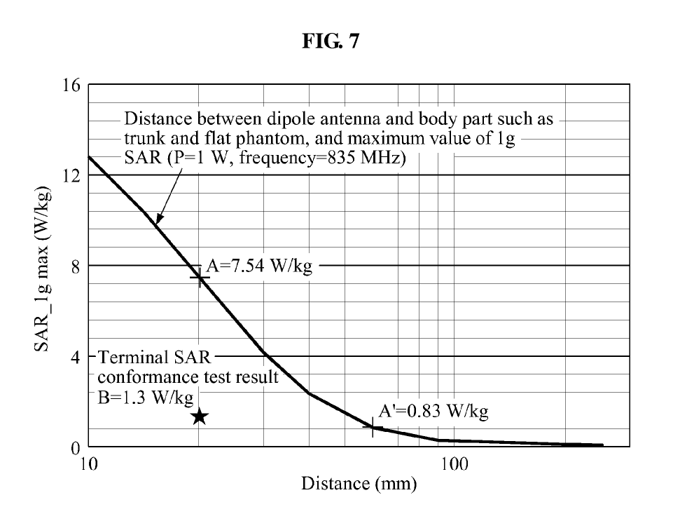

FIG. 7 illustrates a standard SAR for a trunk varying based on a distance between a user and a user terminal according to an example embodiment.

A curve of FIG. 7 may indicate a maximum value of a standard SAR absorbed into a phantom based on a distance between the phantom and a standard source. The standard source may correspond to an antenna of the user terminal. For example, the standard source may correspond to a dipole antenna.

The phantom may correspond to a body part of the user. For example, the standard SAR absorbed into the phantom may correspond to a standard SAR absorbed into a trunk among body parts of the user.

Referring to FIG. 7, the standard SAR may decrease according to an increase in a distance between the phantom and the user terminal, and an inclination may vary based on a frequency.

A frequency of the curve indicated in FIG. 7 may be 835 megahertz (MHz), and an output power of the dipole antenna corresponding to the standard source may be 1 watt (W).

The measure SAR may be determined using Equation 5 below.

$${SAR}_{real time} = \frac{\begin{matrix}{SAR}_{compliance test} ( s 1 , real phone , flat ) \times \\ {SAR}_{numerical analysis} ( s 2 , reference , flat )\end{matrix}}{{SAR}_{numerical analysis} ( s 1 , reference , flat )} \times \frac{{P}_{real time}}{{P}_{compliance test}} \qquad [ Equation 5 ]$$

In Equation 5, SAR_{compliance test} (s1, real phone, flat) denotes a maximum value among standard SARs indicated by the curve of FIG. 7. Thus, SAR_{compliance test} (s1, real phone, flat) denotes a maximum value among standard SARs based on a standard distance s1 between the user and the user terminal.

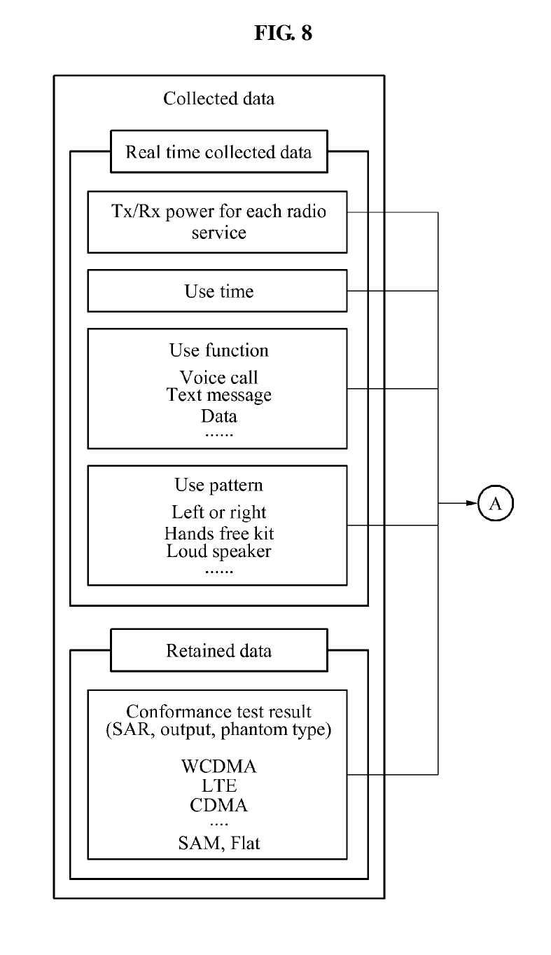

FIG. 8 illustrates data collected and retained in a user terminal according to an example embodiment.

The user terminal may collect a transmission power and a reception power of the user terminal for each radio service.

A measured SAR may vary based on a power of the user terminal. A standard SAR may be extracted based on a standard model. The user terminal may determine the measured SAR more accurately in consideration of an actual status.

The user terminal may collect information associated with the transmission power and the reception power of the user terminal for each radio service.

The user terminal may collect a use time of the user for each radio service. The user terminal may provide the use time for each radio service, and a measured SAR accumulated during a predetermined time. For example, when the user inputs during a predetermined time, the user terminal may provide a measured SAR accumulated during a corresponding time.

The user terminal may collect information on a use function. For example, the user terminal may collect a use time for each of a voice call service, a text message service, and a data service.

The user terminal may set to provide the standard SAR and the measured SAR for a predetermined body part of the user based on the use function. For example, when the user uses the text message service, the user terminal may provide at least one of the standard SAR and the measured SAR for the trunk of the user.

The user terminal may collect information associated with a use pattern.

For example, the user terminal may determine the use pattern by sensing a movement of the user for each radio service. The user terminal may provide a standard SAR and a measured SAR for a predetermined body part among the body parts of the user based on the use pattern. Also, the user terminal may analyze the measured SAR for each use pattern and provide a result of the analyzing.

The user terminal may store, in the database, data associated with a standard SAR for each standard model of the body part of the user.

The standard SAR may vary based on numerous variables such as a type of a radio service, an age of the user, a type of the user terminal, a position of an antenna of the user terminal, a distance between the user and the user terminal, a distance between the user and a base station, and the like.

Through a conformance test based on the numerous variables, the standard SAR may generate the standard model. By storing the standard model in the database, the user terminal may extract a standard SAR corresponding to a request of the user and provide a result of the extracting to the user. In this example, the standard SAR may be more accurately extracted by using a terminal device computer-aided design(CAD) file of a manufacturer.

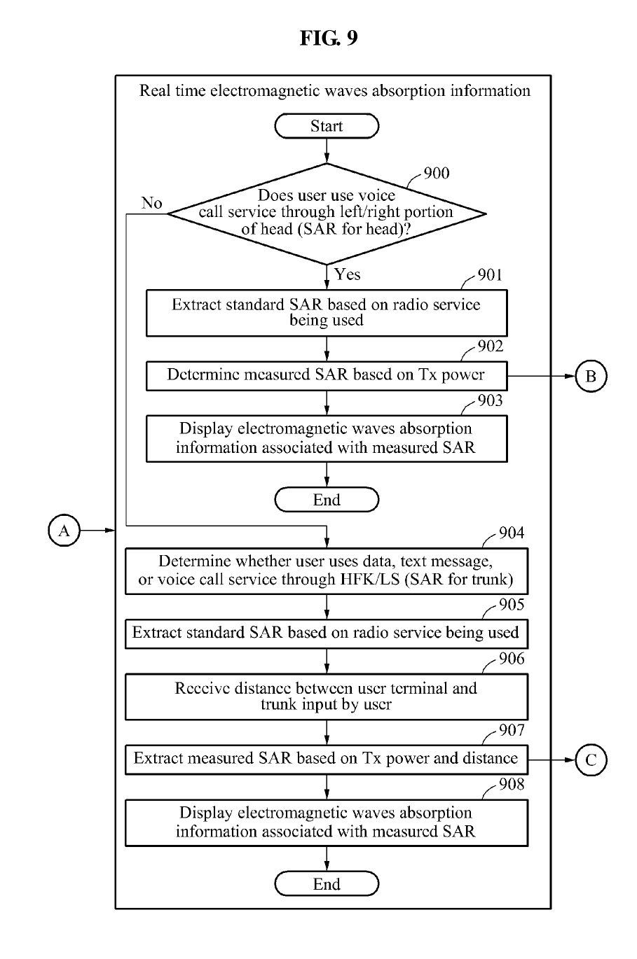

FIG. 9 illustrates an example of providing real time electromagnetic fields absorption information according to an example embodiment.

A user terminal may provide a measured SAR for a head and a trunk among body parts of a user.

Referring to FIG. 9, the user terminal may receive a signal related to a radio service. In response to the receiving, the user terminal may sense a movement of the user sensed by the user terminal. For example, the user terminal may determine a use pattern by sensing a movement of the user changed in the user terminal using a sensor and an interface of the user terminal. Based on the determined use pattern, the user terminal may determine whether the user is making a voice call, using a voice call service using an HFK/LS, using a text message service, or using a data service.

In operation 900, the user terminal may determine whether the user is using the voice call service through a left portion or a right portion of the head.

When the user terminal determines that the user is using the voice call service through the left portion or the right portion of the head, in operation 901, the user terminal may extract a standard SAR for the head of the user.

For example, the user terminal may store a standard model of a body part of the user in a database. The standard model may include information associated with the standard SAR extracted based on numerous variables. Thus, the user terminal may extract a standard SAR corresponding to a request from the user and provide a result of the extracting to the user.

In operation 902, the user terminal may determine the measured SAR for the body part of the user based on a transmission power of the user terminal and the extracted standard SAR.

In operation 903, the user terminal may display electromagnetic fields absorption information associated with the determined measured SAR on a screen of the user terminal.

The user terminal may determine a use pattern by sensing a movement of the user changed in the user terminal using the sensor and the interface of the user terminal. In operation 904, based on the determined use pattern, the user terminal may determine whether the user is using the voice call service through the HFK/LS, using the text message service, or using the data service. When the user terminal determines that the user is using the voice call service through the HFK/LS, using the text message service, or using the data service, in operation 905, the user terminal may extract a standard SAR for a radio service being used by the user.

For example, when the user terminal determines that the user is using the voice call service through the HFK/LS, using the text message service, or using the data service, the user terminal may individually extract the standard SAR absorbed into the trunk of the user based on the radio service being used by the user. In this example, the user terminal may extract the standard SAR based on a standard distance between the user and the user terminal. The standard distance may be set based on a reference established by a manufacturer of the user terminal or a reference established by a government.

In operation 906, the user terminal may receive a distance between the user terminal and the trunk of the user, from the user.

In operation 907, the user terminal may determine the measured SAR based on the received distance. For example, the user terminal may extract the measured SAR by reflecting an actual distance to the standard SAR extracted based on the standard distance.

In operation 908, the user terminal may display the electromagnetic fields absorption information associated with the measured SAR on the screen of the user terminal.

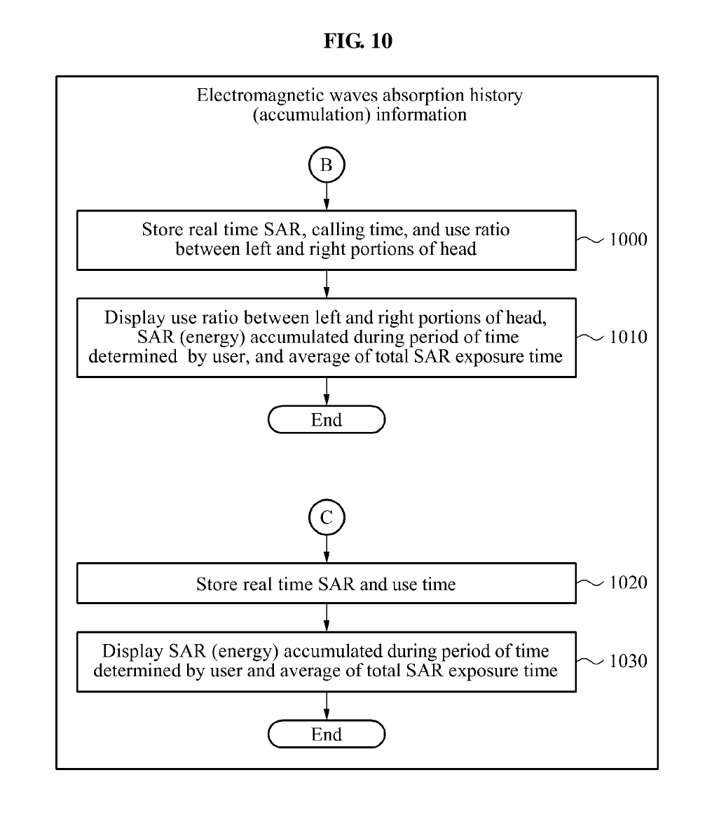

FIG. 10 illustrates an example of providing electromagnetic fields absorption history information according to an example embodiment. Here, the electromagnetic fields absorption history information may be electromagnetic fields absorption accumulation information.

A user terminal may provide a measured SAR for a body part of a user to the user. For example, the user terminal may provide a measured SAR for a head among body parts of the user.

In this example, the user terminal may sense a use pattern of the user during making a voice call, and store the sensed use pattern. In operation 1000, the user terminal may store a real time SAR for a left or right portion of the head, a calling time performed through the left or right portion of the head, and a use ratio between the left portion and the right portion of the head used during the voice call.

In operation 1010, the user terminal may display, on the screen of the user terminal, at least one of a measured SAR accumulated during a period of time determined by the user with respect to the left portion and the right portion of the head among the body parts of the user, an average measured SAR during the period, an amount of SE accumulated during the period, and an exposure time for each radio service.

In operation 1020, the user terminal may store a real time SAR for the trunk among the body parts of the user and a time for using the radio service such as the voice call service based on the HFK/LS, the text message service, the data service, and the like. In operation 1030, the user terminal may display, on the screen of the user terminal, at least one of a measured SAR accumulated during a period of time determined by the user with respect to the trunk among the body parts of the user, an average measured SAR during the period, an amount of SE accumulated during the period, and an exposure time for each radio service.

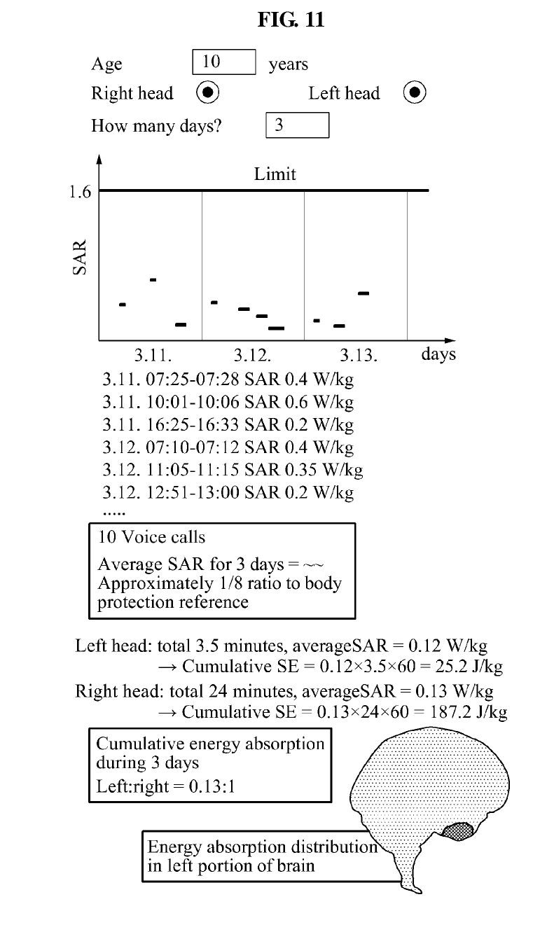

FIG. 11 illustrates electromagnetic fields absorption history information associated with a head of a user according to an example embodiment.

A user terminal may provide electromagnetic fields absorption history information associated with a body part of a user. A screen on which the electromagnetic fields absorption history information associated with the head of the user is displayed may be shown with reference to FIG. 11.

Referring to FIG. 11, the user terminal may provide at least one of information associated with a use time of a left portion and a right portion of a head and a ratio therebetween by analyzing actual environment output information provided by the user terminal, a daily SAR for each calling, an average SAR for a period of use time to be provided, a cumulative SE, exposure information in comparison to a body protection reference, the number of voice calls, a calling time for each calling, a rotation sensor, and the like.

In addition, the user terminal may display a cumulative head absorption distribution based on a 3D cross-section or a 2D cross-section and provide the cumulative head absorption distribution to the user, so as to assist the user to recognize information more easily.

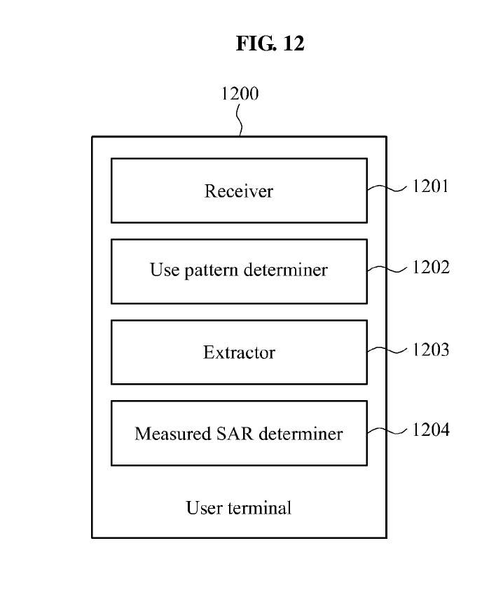

FIG. 12 illustrates a user terminal 1200 to provide a measured SAR corresponding to a body part of a user based on a use pattern of the user terminal 1200 according to an example embodiment.

The receiver 1201 may receive a radio signal related to a radio service. When the receiver 1201 receives the signal, a use pattern determiner 1202 may sense a movement of a user sensed by the user terminal 1200 and identify a use pattern. For example, the use pattern determiner 1202 may identify the use pattern by sensing the movement of the user using a sensor and an interface.

An extractor 1203 may extract a standard SAR for a body part of the user based on the determined use pattern.

The standard SAR may be inversely proportional to a distance between the body part and the user terminal 1200 and thus, vary based on the body part. Thus, the user terminal 1200 may store a standard model of each body part and provide the standard model to the user.

For example, the standard model may be used to extract the standard SAR for the body part of the user based on at least one of an age of the user, a type of the user terminal 1200, and a position of an antenna of the user terminal 1200.

The user terminal 1200 may store the standard SAR extracted based on the standard model in a database. Through this, the extractor 1203 may extract a standard SAR corresponding to information input by the user from the database.

A measured SAR determiner 1204 may determine a measured SAR for the body part of the user based on the standard SAR and a transmission power of the user terminal 1200.

The measured SAR determiner 1204 may determine a measured SAR for a trunk using Equation 6 below.

$${SAR}_{real time} = \frac{\begin{matrix}{SAR}_{compliance test} ( s 1 , real phone , flat ) \times \\ {SAR}_{numerical analysis} ( s 2 , reference , flat )\end{matrix}}{{SAR}_{numerical analysis} ( s 1 , reference , flat )} \times \frac{{P}_{real time}}{{P}_{compliance test}} \qquad [ Equation 6 ]$$

In Equation 6, SAR_{real time} denotes the measured SAR. P_{real time} denotes an actual transmission power of the user terminal 1200, and P_{compliance test} denotes a transmission power measured in the user terminal 1200 when the standard SAR is extracted based on the standard model.

SAR_{compliance test} (s1, real phone, flat) denotes a maximum value of a standard SAR distribution based on a standard distance s1 between the user and the user terminal 1200.

SAR numerical analysis (s2, reference, flat) denotes a standard SAR with respect to an actual measurement distance s2 between the user and the user terminal 1200.)

SAR numerical analysis (s1, reference, flat) denotes a standard SAR with respect to the standard distance s1 between the user and the user terminal 1200.

The measured SAR determiner 1204 may provide a measured SAR for the head of the user. A standard SAR of the trunk may be determined using Equation 7 below.

$${SAR}_{real time} = {SAR}_{numerical analysis} ( {M}_{i} , {Y}_{n} ) \times C \times \frac{{P}_{real time}}{{P}_{compliance test}} \qquad [ Equation 7 ]$$

In Equation 7, SAR_{numerical analysis} (Mᵢ, Yₙ) denotes a standard SAR distribution based on an age Yₙ of the user in a standard model Mᵢ of a terminal of which a type is the same as the user terminal 1200.

Pᵣₑₐₗₜᵢₘₑ denotes the actual transmission power of the user terminal 1200, and P_{compliance test} denotes the transmission power measured in the user terminal 1200 when the standard SAR is extracted based on the standard model.

C may be an SAR modification factor, and expressed as

$$C = \frac{{SAR}_{compliance test} ( real phone , SAM )}{{SAR}_{numerical analysis} ( {M}_{i} , SAM )} .$$

SAR_{compliance test} (real phone, SAM) denotes a maximum value of a standard SAR distribution extracted for the terminal of which the type is the same as the user terminal 1200, and SAR_{numerical analysis} (Mᵢ, SAM) and denotes a standard SAR distribution in the terminal of which the type is the same as the user terminal 1200.

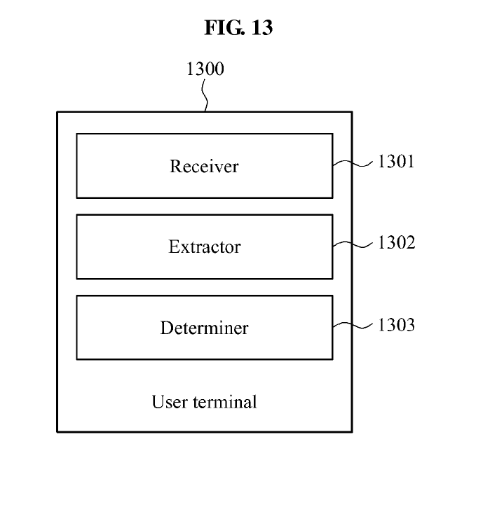

FIG. 13 illustrates a user terminal 1300 to provide a measured SAR for a body part of a user based on a radio service related to a radio signal according to an example embodiment.

A receiver 1301 may receive the radio signal related to the radio service. An extractor 1302 may extract a standard SAR for a body part of the user related to the radio service.

The standard SAR may be extracted based on a standard model. For example, the standard model may be used to extract the standard SAR by disposing an SAM phantom in lieu of the head of the user, and measuring electromagnetic fields absorbed into the SAM phantom based on an age of the user, a type of the user terminal 1300, and a position of an antenna as variables.

Also, a standard SAR of a trunk may be used to extract a standard SAR distribution by disposing a phantom in lieu of the trunk of the user, and measuring electromagnetic fields absorbed into the phantom based on a distance between the phantom and the user terminal 1300.

Thus, the user terminal 1300 may store the standard SAR distribution extracted based on the standard model of the body part of the user in the database, and the extractor 1302 may extract and provide a standard SAR corresponding to a request from the user.

A determiner 1303 may determine a measured SAR for the body part of the user based on the extracted standard SAR and a power of a signal related to a radio service.

The determiner 1303 may determine the measured SAR for the trunk using Equation 8 below.

$${SAR}_{real time} = \frac{\begin{matrix}{SAR}_{compliance test} ( s 1 , real phone , flat ) \times \\ {SAR}_{numerical analysis} ( s 2 , reference , flat )\end{matrix}}{{SAR}_{numerical analysis} ( s 1 , reference , flat )} \times \frac{{P}_{real time}}{{P}_{compliance test}} \qquad [ Equation 8 ]$$

In Equation 8, SAR_{real time} denotes the measured SAR. P_{real time} denotes an actual transmission power of the user terminal 1300, and P_{compliance test} denotes a transmission power measured in the user terminal 1300 when the standard SAR is extracted based on the standard model.

SAR_{compliance test} (s1, real phone, flat) denotes a maximum value of a standard SAR distribution based on a distance s1 between the user and the user terminal 1300.

SAR_{numerical analysis} (s2, reference, flat) denotes a standard SAR of a standard source with respect to an actual measurement distance s2 between the user and the user terminal 1300.

SAR_{numerical analysis} (s1, reference, flat) denotes a standard SAR with respect to the standard distance s1 between the user and the user terminal 1300.

The determiner 1303 may provide the measured SAR of the head of the user. The determiner 1303 may determine the measured SAR for the trunk using Equation 9 below.

$${SAR}_{real time} = {SAR}_{numerical analysis} ( {M}_{i} , {Y}_{n} ) \times C \times \frac{{P}_{real time}}{{P}_{compliance test}} \qquad [ Equation 9 ]$$

In Equation 9, SAR_{numerical analysis} (Mᵢ, Yₙ) denotes a standard SAR distribution based on an age Yₙ of the user in a standard model Mᵢ of a terminal of which a type is the same as the user terminal 1300.

P_{real time} denotes the actual transmission power of the user terminal 1300, and P_{compliance test} denotes the transmission power measured in the user terminal 1300 when the standard SAR is extracted based on the standard model.

C may be an SAR modification factor, and expressed as

$$C = \frac{{SAR}_{compliance test} ( real phone , SAM )}{{SAR}_{numerical analysis} ( {M}_{i} , SAM )} .$$

SAR_{compliance test} (real phone, SAM) denotes a maximum value of a standard SAR distribution extracted for the terminal of which the type is the same as the user terminal 1300, and SAR_{numerical analysis} (Mᵢ, SAM) denotes a standard SAR distribution in the terminal of which the type is the same as the user terminal 1300.

According to an aspect of the present invention, it is possible to provide an SAR provision method enabling a user to individually recognize a state for each body part of the user by providing the SAR for each body part to the user, and a user terminal for providing the SAR.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A specific absorption rate (SAR) provision method comprising:
receiving a radio signal related to a radio service;
determining a use pattern of a user sensed by a user terminal in response to the receiving;
extracting a standard SAR for a body part of the user based on the determined use pattern; and
determining a measured SAR for the body part of the user based on the extracted standard SAR and a transmission power of the user terminal.

2. The method of claim 1, wherein the extracting comprises extracting the standard SAR for the body part of the user based on at least one of an age of the user, a type of the user terminal, and a position of an antenna of the user terminal.

3. The method of claim 1, wherein the extracting comprises extracting the standard SAR for the body part of the user based on a standard distance between the user and the user terminal.

4. The method of claim 1, wherein the determining of the measured SAR comprises determining the measured SAR for the body part of the user based on an actual distance between the user and the user terminal.

5. The method of claim 1, wherein the determining of the measured SAR comprises determining a measured SAR for at least one of a left portion and a right portion of a head of the user based on a movement of the user sensed by the user terminal.

6. The method of claim 1, further comprising:
displaying at least one of the standard SAR, the measured SAR, a standard SAR accumulated during a predetermined time, and a measured SAR accumulated during the predetermined time for the body part of the user.

7. A specific absorption rate (SAR) provision method comprising:
receiving a radio signal related to a radio service;
extracting a standard SAR for a body part of a user related to the radio service; and
determining a measured SAR for the body part of the user based on the extracted standard SAR and a power of the radio signal.

8. The method of claim 7, wherein the extracting comprises extracting the standard SAR for the body part of the user based on a standard distance between the user and a user terminal.

9. The method of claim 7, wherein the determining comprises determining the measured SAR for the body part of the user based on an actual distance between the user and a user terminal.

10. The method of claim 7, further comprising:
displaying at least one of the standard SAR, the measured SAR, a standard SAR accumulated during a predetermined time, and a measured SAR accumulated during the predetermined time for the body part of the user.

11. A user terminal comprising:
a receiver to receive a radio signal related to a radio service;
a use pattern determiner to determine a use pattern of a user sensed by the user terminal in response to receiving of the radio signal;
an extractor to extract a standard SAR for a body part of the user based on the determined use pattern; and
a measured SAR determiner to determine a measured SAP for the body part of the user based on the extracted standard SAR and a transmission power of the user terminal.

12. The terminal of claim 11, wherein the extractor extracts the standard SAR for the body part of the user based on at least one of an age of the user, a type of the user terminal, and a position of an antenna of the user terminal.

13. The terminal of claim 11, wherein the extractor extracts the standard SAR for the body part of the user based on a standard distance between the user and the user terminal.

14. The terminal of claim 11, wherein the measured SAR determiner determines the measured SAR for the body part of the user based on an actual distance between the user and the user terminal.

15. The terminal of claim 11, wherein the measured SAR determiner determines a measured SAR for at least one of a left portion and a right portion of a head of the user based on a movement of the user sensed by the user terminal.

16. The terminal of claim 11, wherein the user terminal displays at least one of the standard SAR, the measured SAR, a standard SAR accumulated during a predetermined time, and a measured SAR accumulated during the predetermined time.
